(19) United States
(12) Patent Application Publication
(10) Pub. No.: US 2016/0078579 A1
(43) Pub. Date: Mar. 17, 2016

(54) Method Implemented on Portable Electronic Device to Invoke Legal Rights

(71) Applicant: Jennifer Yang, Palo Alto, CA (US)

(72) Inventor: Jennifer Yang, Palo Alto, CA (US)

(21) Appl. No.: 14/484,275

(22) Filed: Sep. 12, 2014

(51) Int. Cl. G06Q 50/26; H04L 12/58; G06Q 50/18

(52) U.S. Cl. CPC G06Q 50/265; G06Q 50/18; H04L 51/38

(57) ABSTRACT

A method implemented on portable electronic device for assisting users to properly invoke legal right(s) is provided, whereby a user uses an electronic device to either display a text message or play an audio message, or both, stating that the user chooses to invoke his or her legal right(s), initiate a phone call or email, or both, to seek legal assistance, display a text message reminding the user that he or she has invoked his or her legal right(s).

### TECHNICAL FIELD

The present invention relates to a method or system for assisting users to invoke legal right(s), especially for users lacking the legal knowledge to properly invoke his or her legal right(s), and for users lacking English language skills to invoke his or her legal right(s) in English.

### BACKGROUND OF THE INVENTION

When an individual is subject to direct questioning or its functional equivalent by law enforcement agent(s), the individual has the Fifth Amendment right against compelled self-incrimination and the Sixth Amendment right to counsel. In a historical case, Miranda v. Arizona (1966), the US supreme provided specific guidelines as to how the right against self-incrimination and the right to counsel apply in custodial interrogation situation. In Miranda, the supreme court held, “ . . . . The person in custody must, prior to interrogation, be clearly informed that he/she has the right to remain silent, and that anything the person says will be used against that person in court; the person must be clearly informed that he/she has the right to consult with an attorney and to have that attorney present during questioning, and that, if he/she is indigent, an attorney will be provided at no cost to represent him/her.” These rights have been commonly referred to as the Miranda rights.

However, the Miranda rights do not automatically attach when a person is questioned by law enforcement agent(s). These rights must be explicitly invoked by the individual under custody. In another recent landmark case, SALINAS v. TEXAS (2013), the Supreme Court held that an individual under custody must explicitly and specifically refer to the right against self-incrimination and the right to counsel, or collectively the Miranda rights, in order to invoke these legal rights. Merely refusing to answer questions does not automatically invoke the individual's Miranda rights. This landmark decision shifted the burden to the individual under custody to invoke his or her legal right(s) by using specific legal terms. Such burden is even more prohibitive, if the individual under custody lacks the necessary English skills to invoke his or her legal right(s).

The above described situation creates the need for a method, which provides a way for an individual to properly invoke his or her legal right(s). The advance of electronic technology has made electronic devices, particularly the personal mobile electronic devices, widely available and accessible. Majority of the personal mobile electronic devices, such as smartphones, are capable of displaying text message and playing audio messages. Therefore, a method implemented on electronic device can be created to help an individual to properly invoke his or her legal right(s), including Miranda rights.

### SUMMARY OF THE INVENTION

It is an object of the present invention to provide a method or system for assisting users, who either lack the necessary legal knowledge or the necessary English language skills, to properly invoke legal right(s) through an electronic device. According to the present invention, the object above is achieved through a method implemented on computer based electronic devices to display a text message specifically stating that the individual showing the text message affirmatively invoke certain legal right(s). Along with the text message, it also plays an audio message specifically stating that the individual playing the audio message affirmatively invoke certain legal right(s). In addition, it also provides an access to initiate a phone call and/or email to seek legal assistance, such as a phone call or email to the user's attorney. Another text message is also displayed to remind the user that his or her legal right(s) have been invoked and what protection these legal right(s) afford. This reminder message to the user can be provided in the user's preferred language.

The present invention can be implemented in different ways. One way is to implement the method as an html based web application. The web page can be launched from any tool or application, which can render html page with audio content, on the portable electronic device. Such tools or applications includes mobile web browsers and WeChat (a popular mobile text and voice messaging tool). In the alternative, the present invention can also be implemented as a smartphone app, which can be installed on smartphones or other portable electronic devices that support the app.

A typical implementation of the present invention on a smartphone to invoke Miranda rights and right to counsel works in the following way. A user launches an application on the smartphone, the application displays a first message stating that the user affirmatively invoke his or her Miranda rights to remain silent and right to counsel. Below the first message, there is a second message, in either English or the user's preferred language, reminding the user that he or she has invoked his or her Miranda rights to remain silent and his or her right to counsel. The application retrieves the user's attorney's contact information including phone number and email address, either from a remote server via the Internet or from the local storage on the smartphone. Based on contact information, a clickable link to launch a phone call to the user's attorney and a clickable link to initiate an email to the user's attorney are provided below the second message. If the user does not have an attorney, the phone call or email will be directed to an entity, which can provide legal assistance or attorney referral.

### BRIEF DESCRIPTION OF THE DRAWINGS

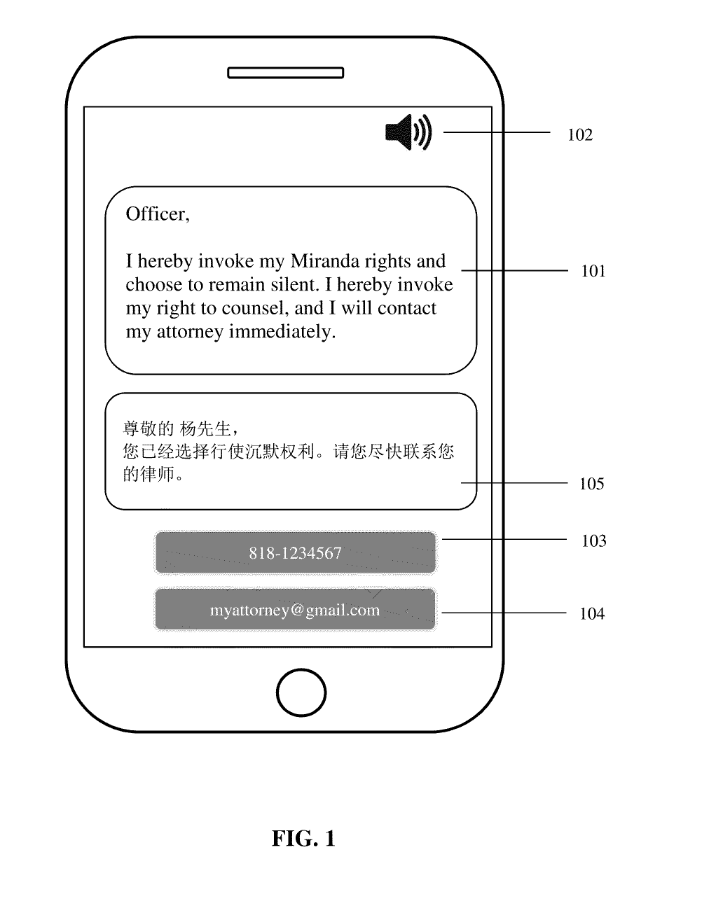

FIG. 1 is an example of a typical embodiment of the present invention on a smartphone.
101 A text message stating that the user chooses to invoke his or her
Miranda rights to remain silent and right to counsel.
102 A clickable button to play (or replay) an audio message stating that the user chooses to invoke his or her Miranda rights to remain silent and right to counsel.
103 A clickable button to initiate a phone call to the user's attorney.
104 A clickable button to initiate an email to the user's attorney.
105 A text message in Chinese reminding the user that he or she has invoked his or her Miranda rights to remain silent and right to counsel.

What is claimed is:

1. A method implemented on portable electronic device to invoke legal right(s), comprising:
displaying a text message on a screen of a portable electronic device stating that a user showing said text message chooses to invoke said user's legal right(s); and
playing an audio message from said portable electronic device stating that said user playing said audio message chooses to invoke said user's legal right(s).

2. A method implemented on portable electronic device to invoke legal right(s), further comprising:
displaying a first text message on a screen of a portable electronic device stating that a user showing said text message chooses to invoke said user's legal right(s);
playing an audio message from said portable electronic device stating that said user playing said audio message chooses to invoke said user's legal right(s); and
displaying a second text message on said screen of said portable electronic device reminding said user that said user has invoked said user's legal right(s).

3. The method of any of claims 1 to 2, further comprising:
retrieving a contact information of an intended party from a digital storage; and
receiving a request from a user to initiate a communication to said intended party using said contact information.

4. The method according to claim 3, wherein said intended party is said user's attorney.

5. The method according to claim 3, wherein said intended party is an organization providing attorney referral services.

6. The method according to claim 3, wherein said contact information is a phone number; and said communication is a phone call.

7. The method according to claim 3, wherein said contact information is an email address; and said communication is an email.

8. The method according to claim 3, wherein said digital storage is on a remote server accessible through a wireless telecommunications network.

9. The method according to claim 3, wherein said digital storage is located locally on said portable electronic device.

10. The method according to claim 3, wherein said portable electronic device is a smartphone.

11. The method of any of claims 1 to 2, further comprising, further comprising: receiving a request from said user to replay said audio message.

12. The method of any of claims 1 to 2, wherein said legal rights are Miranda Rights.

13. The method of any of claims 1 to 2, wherein said legal right is right to counsel.

14. The method according to claim 2, wherein said second text message is in a language other than English.

15. The method according to claim 14, wherein said second language is Chinese.
